(19) United States
(12) Patent Application Publication
(10) Pub. No.: US 2008/0163444 A1
(43) Pub. Date: Jul. 10, 2008

(54) Aquarium Cleaner

(76) Inventor: Mark William Schwartz, Wauconda, IL (US)

Correspondence Address: Heather A. Kartsounes, Suite 210, 520 W. Erie St., Chicago, IL, 60610, US

(21) Appl. No.: 11/970,056

(22) Filed: Jan. 7, 2008

Related U.S. Application Data
(60) Provisional application No. 60/883,623, filed on Jan. 5, 2007.

(51) Int. Cl. B08B 9/087; A47L 17/06; A47L 13/08

(52) U.S. Cl. 15/236.01

(57) ABSTRACT

This surface cleaner that is used on aquarium surfaces will comprise at least one razor blade 8; housing comprising inner housing 4 and outer housing 12; at least one magnet 14. The razor blade 8 is to be housed within the inner housing 4 and can be controlled by a switch 6. To clean a surface, a user activates the razor blade 8 and placing the inner housing 4 on the surface 10 that is to be cleaned. The outer housing 12 is matched up with the inner housing 4 and held together by the magnetic attraction between the magnets 14. A user simply moves the outer housing 12 along the surface 10 and the inner housing 4 will scrape the surface 10 clean by way of the razor blade 8.

### FIELD OF THE INVENTION

This invention relates to an aquarium cleaner. More specifically it relates to an aquarium cleaner that utilizes razor blades and magnetic forces to clean the surface of the aquarium.

### BACKGROUND OF THE INVENTION

Owners of aquariums are constantly battling the problem of algae over growth. The surfaces of the aquarium tank become covered in algae making the tank dirty and difficult to see into. Cleaning an aquarium is not a desirable task as it is labor intensive and can be shocking or dangerous for the animals that reside inside. As such, developments have been made to facilitate the cleaning process.

Current tools that assist in the cleaning process are scrub brushes and razor blades on a long pole that allow a user to scrub or scrape without having to reach inside the tank. While this can be helpful, it is often times dangerous to both the user and to the animals who reside inside the tank to be subjected to an open razor blade. While scrub brushes assist in cleaning, they still need an extensive amount of user labor to adequately clean a surface. Another tool that assists in the cleaning process is one that utilizes a scrub brush and magnetic forces. A scrub brush is inserted into the tank and controlled from outside the tank by magnetic forces. While this is a step in the right direction for assisting users of aquariums, it is not highly effective in adequately cleaning the surface of an aquarium.

This invention describes a surface cleaner that comprised of both magnets and razor blades in a safe, yet efficient tool.

### SUMMARY OF THE INVENTION

This invention relates broadly to the following:
a surface cleaner comprising
   at least one razor blade;
   housing comprising inner housing and outer housing;
   at least one magnet.

The surface cleaner will be described in terms of cleaning the surface of an aquarium, however one skilled in the art will recognize that that it is possible to use this invention on a wide variety of surfaces.

The inner housing comprises at least one razor blade. It is recognized that that more then one razor blade may be utilized. The razor blade is controlled by a switch on the inner housing. This switch is to allow for the razor blade to have a retracted and activated position. A retracted position is desirable so that the razor blade will not become a safety hazard while it is not in use. When it is desired to use the surface cleaner, the switch should be put in the position to activate the razor blade.

The inner and outer housings each comprise at least one magnet. The inner housing will comprise a magnet set to one pole and the outer housing will comprise a magnet set to the opposite, attracting pole. The inner and outer housings are to be magnetically attracted to each other.

When a user desires to clean a surface, he or she simply needs to activate the razor blade within the inner housing and place the inner housing on the side of the surface that is to be cleaned. In cases of an aquarium, this would be the inner surface of the aquarium. The outer housing is to be matched up to the inner housing on the opposite side of the surface. The magnets will hold the inner and outer housing together.

To clean a surface, a user simply needs to hold the outer housing and move it across the surface. This action will in turn move the inner housing causing the razor blades to scrape clean the surface. In the instance of an aquarium surface, the razor will simply scrape all algae off the surface of the tank. The algae will either collect within the inner housing or will fall to the bottom of the aquarium.

One skilled in the art will recognize that razor blades as a cleaning device can be harsh to a surface. In instances where a surface cannot withstand the scraping by a metal razor blade, other options are available. It is anticipated that a wide variety of materials may be fashioned to form a blade that is suitable for certain surfaces. It is also anticipated that an inner housing may house more then one type of razor blade.

One skilled in the art will also recognize that it may be necessary to give this invention the ability to float in water. This will make it easier for a user if the aquarium cleaner is dropped or otherwise loses its magnetic connection temporarily.

Other advantages and aspects of the present invention will become apparent upon reading the following description of the drawings and the detailed description of a preferred embodiment of the invention.

### DETAILED DESCRIPTION OF THE DRAWINGS

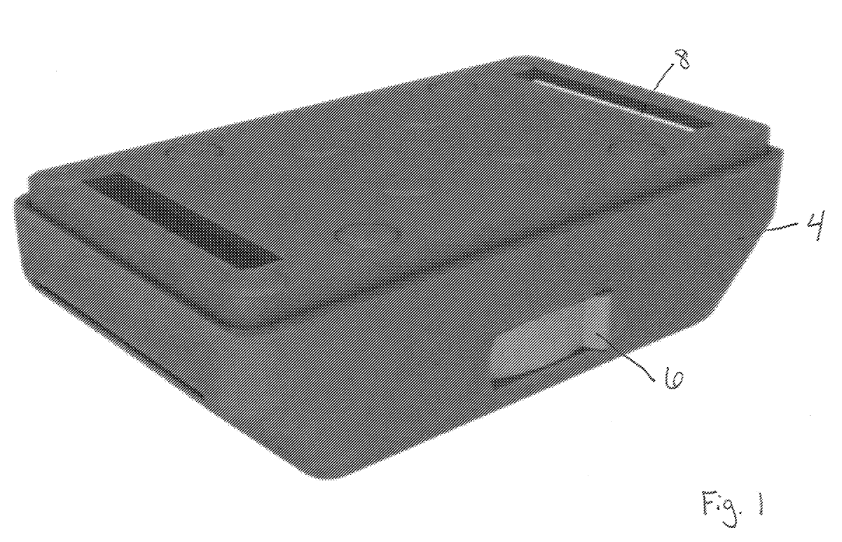

FIG. 1 is a depiction of the inner housing with the razor blade retracted.

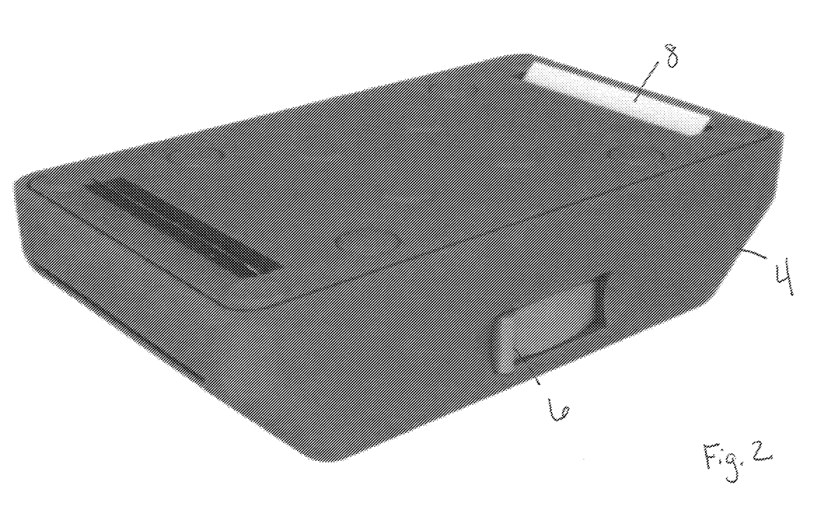

FIG. 2 is a depiction of the inner housing with the razor blade activated.

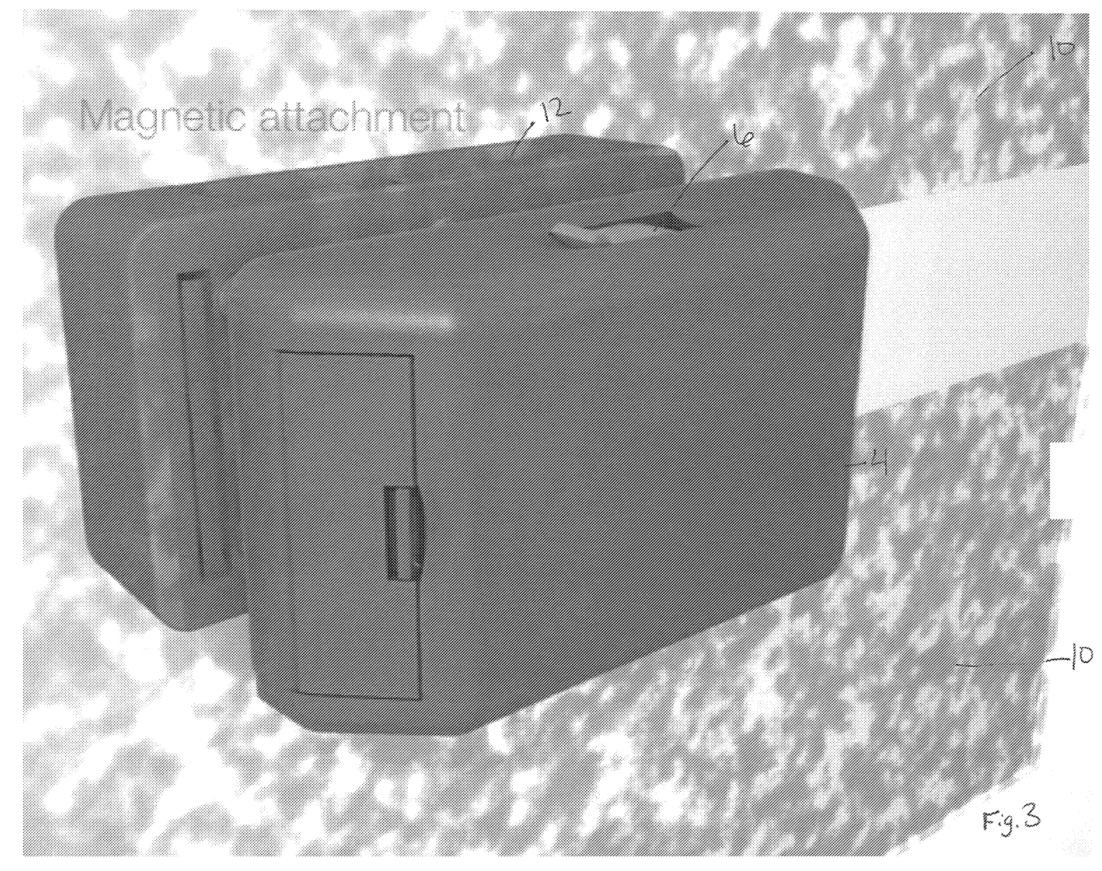

FIG. 3 depicts the magnetic attraction between the inner and outer housings on the surface of the aquarium.

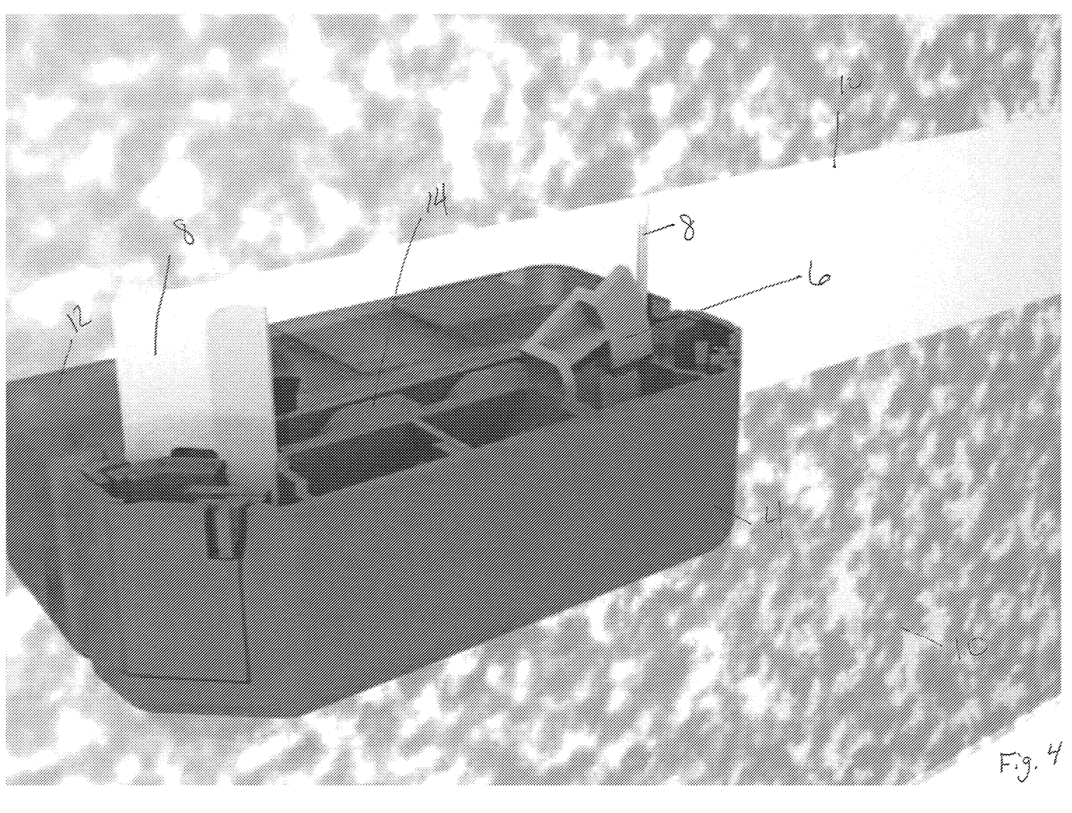

FIG. 4 is a cross sectional view of the inner and outer housings on the surface of the aquarium.

### DETAILED DESCRIPTION OF THE PREFERRED EMBODIMENT

In its preferred embodiment, this surface cleaner that is used on aquarium surfaces will comprise at least one razor blade 8; housing comprising inner housing 4 and outer housing 12; at least one magnet 14. The razor blade 8 is to be housed within the inner housing 4 and can be controlled by a switch 6. This switch 6 can control the position of the razor blade from the retracted position seen in FIG. 1 to the activated position seen in FIGS. 2-4.

The inner housing 4 and the outer housing 12 each comprise of a magnet 14 of opposite poles from each other. This is so the inner housing 4 and outer housing 12 will be attracted to one another.

To clean a surface, like the aquarium surface 10 seen in FIGS. 3 and 4, a user simply needs to activate the razor blade 8 and placing the inner housing 4 on the surface 10 that is to be cleaned. In the figures, this is the surface on the inside of the aquarium where the algae grows. The outer housing 12 is matched up with the inner housing 4 and held together by the magnetic attraction between the magnets 14. A user simply moves the outer housing 12 along the surface 10 and the inner housing 4 will scrape the surface 10 clean by way of the razor blade 8.

To store the surface cleaner, one simply needs to remove it from the surface 10 and retract the razor blade 8 inside the inner housing 4 for safety.

The invention may be described in terms of claims that can assist the skilled reader in understanding the various aspects and preferments of the invention. It will be appreciated by those skilled in the art that many modifications and variations may be made to the embodiments described herein without departing from the spirit and scope of the invention.

What is claimed is:

1. A surface cleaner comprising
at least one razor blade;
housing comprising inner housing and outer housing;
at least one magnet.

2. The surface cleaner as in claim 1 wherein said at least one razor blade is housed within said inner housing; said inner housing further comprises a magnet of one pole; said outer housing further comprises a magnet of opposite pole from said inner housing.

3. The surface cleaner as in claim 2 wherein said inner housing comprises a switch to activate said at least one razor blade.

4. The surface cleaner as in claim 3 wherein said at least one razor blade in activated position within said inner housing can be placed on a surface and held into place by attracting magnetic poles between said inner and outer housing.

5. The surface cleaner as in claim 4 wherein movement of said outer housing controls movement of said inner housing along with said at least one razor blade when magnetic poles are attracted.
